(19) United States
(12) Patent Application Publication
(10) Pub. No.: US 2004/0187992 A1
(43) Pub. Date: Sep. 30, 2004

(54) Quick change tires, rims, and wheels

(76) Inventor: Lewis R. Thomas, Fort Worth, TX (US)

Correspondence Address: Lewis R. Thomas, 4241 Wiman Dr., Fort Worth, TX, 76119, US

(21) Appl. No.: 10/395,586

(22) Filed: Mar. 24, 2003

(51) Int. Cl. B60C 1/00

(52) U.S. Cl. 152/151

(57) ABSTRACT

The quick change rims and wheels are designed to eliminate a lot of the hassles associated with changing a deflated bicycle tire. The rim has spoke locking holes for a single spoke (10) and spoke locking holes for a double spoke (15) wheel. Thus making the rim interchangeable. The spokes have locking springs (35) which keeps the rim securely attached to the wheel. Removal of the rim is accomplished by pressing the locking springs (35) inward. Replacement of a new tire (30) simply requires that you pushes the rim upward onto the spoke (45) until the locking springs (35) clicks. If the user is running tubes with his or her tire (30), the air stem (65) can be removed so that the inner tube stem may be inserted there. Double spoke (45) wheels are strong enough by themselves to stabilize the rim and maintain proper alignment. However, when using a single spoke (45) wheel, the alignment stabilizer plate (55) should be used. The plate has stabilizer locking springs (50) to hold one rim and tire close to the next. This gives strength and stability to your tires while maintaining alignment in the unlikely event that your tires should hit a pothole or bump while you are riding it.

### CROSS REFERENCE TO RELATED APPLICATION

Not applicable

### BACKGROUND

1. Field of Invention

This invention relates to the speedy replacement of a deflated tire on a bicycle, but not limited solely thereto.

2. Description of Prior Art

When man first invented the wheel, it was not round and made of stone. This made for a very uncomfortable ride. Later, some of the corners were rounded off. This improved the ride, but did not give it the comfort as we know it today.

The wheel underwent a metamorphism and changed from stone to wood, wood to steel, and steel to rubber. During this transformation, shock absorption was added to the ride. This improved the wheel immensely, but there was still one problem. The tire was made out of solid rubber.

By hollowing out the tire and added an inner tube to it, this gave us the ride and comfort that we enjoy today. Prior to this occurrence, man only had to deal with the wheel coming off. The hollowed wheel brought with it a new problem, flats!

Sharp items would puncture the inner tube and cause the entire tire to deflate. Since my invention relates to bicycle tires (but limited solely thereto), I will discuss this effect on bicycle tires. Usually, when a puncture occurs, it happens in only about 0.000001 of the tire, but its effect is felt throughout the entire tire. Air leaves the tire through this tiny hole.

Unlike a car, most bicycles do not carry a spare tire. The rider has to dismount, take the deflated tire off, remove the inner tube (if the tire has one), patch the hole, then reverse the process. If this person is trapped away from his or her tools, this could become an even greater problem. My inspiration for this invention came from seeing a man broke down in the desert with a flat tire on his bicycle. Night was approaching and he was stranded on side of the highway repairing his bicycle tire If the man had a spare tire, like in a car, the process would have been a little less painful.

### SUMMARY

In accordance with the present invention, a quick-change tire affords its user the luxury of ease of transport and speed of replacement.

### OBJECTS AND ADVANTAGES

Since a puncture to a tire only affects a small percentage of the tire, why punish the whole tire? With the quick-change tire, you simply remove and replace the flatten section. If you think about it, the entire tire is not flat, just those part where the penetration occurred. Like regular tires, the quick-change tire comes with tubes and tubeless.

The quick-change tire is small enough to be transported on the bicycle's frame. The user may carry more than one quick-change tire with them. Since the quick-change tire is already inflated, tire repair is not an issue at the present moment. Just release the tire from the spoke and snap another into its place. The flat section can be repaired later.

The quick-change tire has a carrying case, which holds three tires. It would be a rare occurrence to have three flats in one outing, but it could happen. The user can carry as many extra tires as he or she wishes.

Still further objects and advantages may become apparent from a consideration of the ensuing descriptions and drawings.

### DRAWING FIGURES

In the drawings, closely related figures might have the same number but different alphabetic suffixes.

FIG. 1 shows a quick change rim with spoke locking holes, rim lock slots, and air inlet.

FIG. 2 shows a quick-change tire.

FIG. 3 shows a locking mechanism inside of a spoke.

FIG. 4 shows an alignment stabilizer plate.

FIG. 5 shows an air stem.

### REFERENCE NUMERALS IN DRAWINGS

10 spoke locking hole for a single spoke

15 spoke locking holes for a double spoke

20 air stem hole

25 alignment stabilizer plate connection

30 a quick change tire

35 a rim locking spring

40 bolt

45 spoke tip

50 stabilizer locking springs

55 an alignment stabilizer plate

60 post

65 an air stem

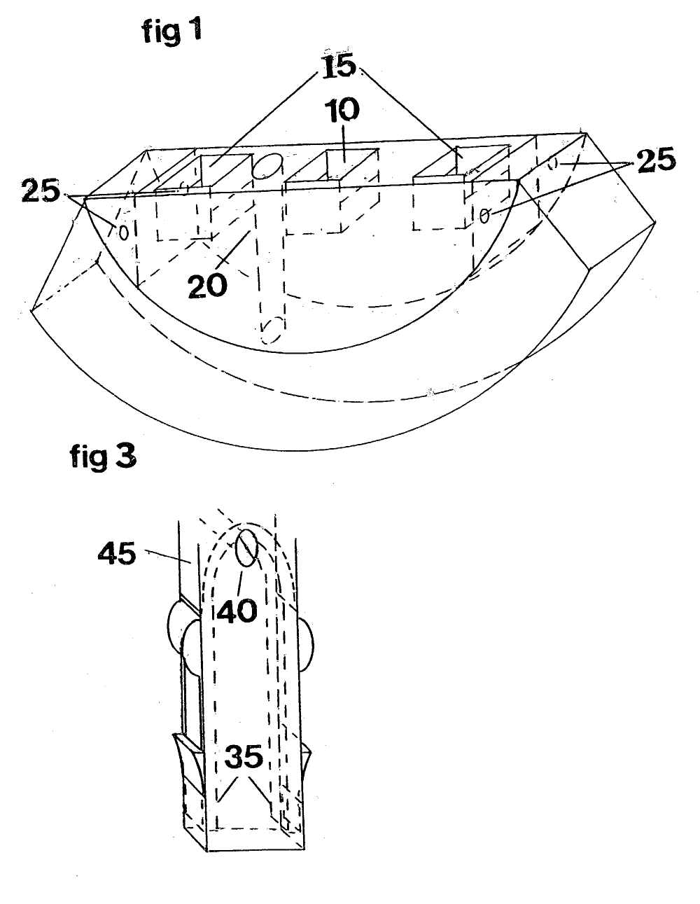

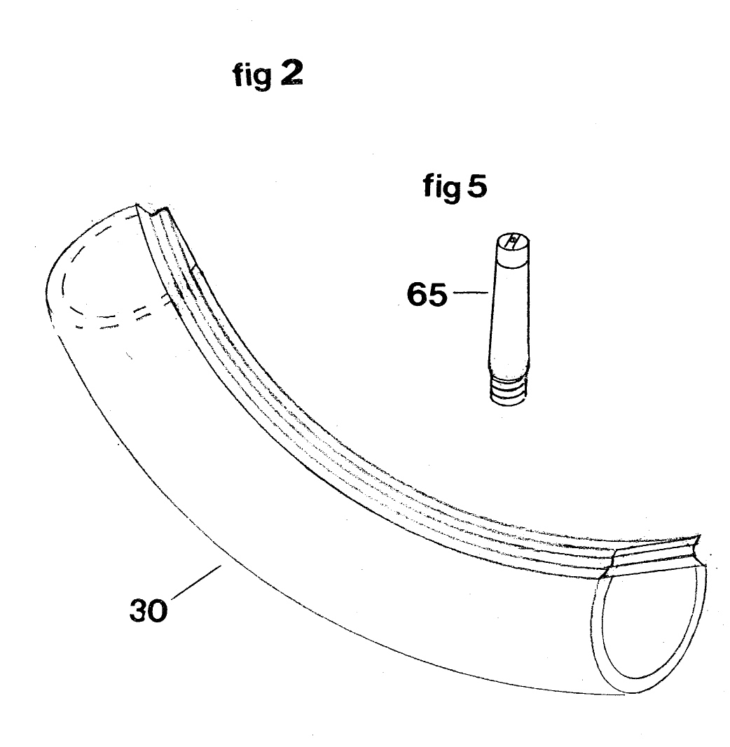

### DESCRIPTION—FIGS. 1-5—PREFERRED EMBODIMENT

A preferred embodiment of the tire, rim, and spoke of the present invention is illustrated in FIGS. 1-5. The spoke tip 45 in FIG. 3 has a hollowed end which houses a rim locking spring 35. The rim locking spring 35 is held in place by a bolt 40. The rim locking spring 35 has a protruding mound on each side which when pressed inward, releases the spoke tip 45 from the rim locking hole 10 or rim locking hole 15.

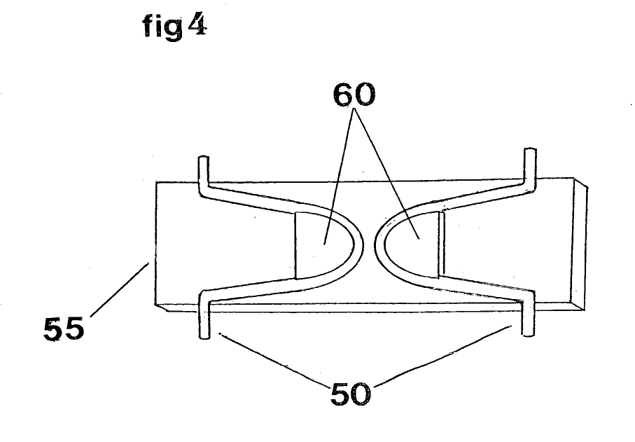

FIG. 1 shows a quick change rim with spoke locking holes 15 for a double locking spoke tip 45 and a spoke locking hole 10 for a single locking spoke tip 45. The air stem hole 20, allows for the insertion of either an air stem 65 in FIG. 5 or the air stem from an inner tube. The alignment stabilizer plate 55 in FIG. 4 is recommended for use with single spokes 45.

The stabilizer locking springs 50, are held securely in place by a post 60. The alignment stabilizer plate 55, fits between the stabilizer plate connection 25 in FIG. 1 with the stabilizer locking springs 50, locked into the stabilizer plate connection 25 holes. The alignment stabilizer plate 55, gives strength, stability, and uniformity to the wheels, helping to maintain alignment of all of the quick-change tires 30 and rims in FIG. 1.

The quick change tire 30, attaches to the bottom of a quick change rim in FIG. 1

Advantages

The quick-change rim is designed to fit either a single or double spoke wheel. The number of sections that the tire can be divided into is determined by the manufacturer.

In this system, only the damaged piece need be removed and replaced in a few e seconds.

Operation

All of the parts in FIGS. 1-5, come pre-assembled. The quick-change tire 30, is attached to the quick-change rim in FIG. 1. If the quick-change tire 30 is tubeless, it can be inflated by the air stem 65, which screws into the air stem outlet 20.

If the wheel is a single spoke 45, it will be inserted into the single spoke-locking hole 10. If it is a double spoke wheel, the spokes 45, will be inserted into the double spoke locking holes 15. They must be pressed down until the rim locking springs clicks (locks).

On a single spoke rim, the alignment stabilizer plate 55, should be used. Press the stabilizer locking springs 50, inward until they align with the alignment stabilizer plate connection 25 holes.

To remove the rims, simply press the mounds on the rim locking springs 35, inward while pushing or pulling downward on the tire 30

Conclusion, Ramifications, and Scope

The quick-change rim in FIG. 1 and quick-change tire are designed for speed, simplicity, and ease of use. It snaps on and falls off when released. Wheel design is not as important to me as the spoke ends, hence, design and number of sections used to complete a round wheel is the discretion of the manufacturer, though two minimum and five maximum are recommended.

The tire types and sizes may vary. The rims must be made to conform to the tires width and size and vice versa.

The quick change tires, rims, and wheels design is not limited solely to bicycle tires, rims, and wheels.

I claim:

1. In a quick change tire, rim, and wheel configuration, parts may be transported easily and be replaced interchangeably with both speed and ease.

2. The tire in claim 1 is made of rubber or a synthetic rubber-like material.

3. Said tire may require a tire or be tubeless.

4. If said tire in claim 3 is tubeless, an air stem must be attached to the rim in claim 1 for inflating purposes.

5. If said tire in claim 3 requires an inner tube, the inner tube's air stem shall be inserted into the air stem inlet of said rim in claim 1.

6. Once inflated, said tire will remain attached to said rim.

7. The wheel in claim 1 has two components which keeps said rim attached.

8. One of the two said components in claim 7 is a locking spring, which holds said rim snugly to it as centrifugal force works against it.

9. The second of the said two components is a bolt which passes through the spoke and under said locking spring, preventing said spring from being pulled out.

10. Said rim in claim 7 may be attached by either a single or double spoke.

11. An alignment stabilizer plate should be used on said rims that are secured by a single spoke in order to maintain alignment and stability throughout said wheel.

12. Said plate in claim 11 has two locking springs which allows it to attach to two said rims simultaneously.

13. Said springs in claim 12 are held in place by a post to prevent slippage in said plate.

14. Said plate in claim 11 comes to rest in the alignment stabilizer plate connection after installation.

15. By pressing said locking springs in claim 8, this will allow said rim to be detached.

16. By pressing another said rim onto a single-spoke or double-spoke in claim 10, the replacing of said tire is complete after it locks into place.
